(19) United States
(12) Patent Application Publication
(10) Pub. No.: US 2003/0202128 A1
(43) Pub. Date: Oct. 30, 2003

(54) Cathode-ray tube

(76) Inventors: Shiro Kenmotsu, Saitama (JP); Mitsuo Hashimoto, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/312,041

(22) PCT Filed: Apr. 26, 2002
(86) PCT No.: PCT/JP02/04249

(51) Int. Cl. H04N 5/65

(52) U.S. Cl. 348/821; 445/8

(57) ABSTRACT

The present invention is to provide a cathode-ray tube capable of improving an anti-explosion characteristic as compared with an arrangement of a prior-art cathode-ray tube and which can be reduced in weight while maintaining a satisfactory anti-explosion characteristic.

A cathode-ray tube 1 has an arrangement in which a film 10 is attached to a face panel 6 of a cathode-ray tube assembly 2 and in which this film is formed by laminating a plurality of films 11 and 12.

### TECHNICAL FIELD

The present invention relates to a cathode-ray tube in which a film is attached to a face panel of a cathode-ray tube assembly.

### BACKGROUND ART

As an arrangement for achieving an anti-explosion effect by reinforcing a cathode-ray tube assembly of a cathode-ray tube, there have hitherto been known various arrangements for reinforcing a cathode-ray tube assembly, such as a band reinforcement type arrangement in which a cathode-ray tube assembly is fastened with pressure by winding a steel band around a skirt portion of a face panel of the cathode-ray tube assembly or a panel reinforcement type arrangement in which a plurality of sheets of reinforced plate glass, each having a similar curvature, are disposed on a face panel at a predetermined space and in which a flexible transparent liquid resin or the like is injected into and cured in the spaces.

Most of the recent cathode-ray tubes are adapted to employ the band reinforcement type arrangement out of these reinforcement type arrangements.

According to the band reinforcement type arrangement, after a protection tape such as a polyethylene tape has been attached to an outer periphery near a frit-seal portion at which a panel portion and a funnel portion of a cathode-ray tube assembly are joined, fore example, a steel band is wound around the skirt portion of the face panel of the cathode-ray tube assembly by a suitable method such as a heat shrink treatment.

Further, a resin film, which has been treated by a suitable treatment method such as an anti-reflection coating or an antistatic coating treatment, i.e., a functional film is attached to the face panel which is the front surface of the panel portion.

Thanks to this functional film, it is a well-known fact that a cathode-ray tube can improve a picture quality and have a feel of super quality as a commercial product. Further, this functional film may achieve an anti-explosion effect so that glass of the panel portion can be prevented from being scattered to the front surface.

As the above-mentioned functional film, there is generally used a sheet of film having a thickness ranging from 100 to 200 μm and which is cut into the minimum size so that this film may become larger than an effective picture screen in accordance with a curvature of an outer surface of a panel glass, for example, and which may not cover a so-called blend R portion which is a curved surface extending from the surface of the face panel to the skirt portion.

It has been considered that a cathode-ray tube should be reduced in weight by decreasing a thickness of glass, for example, as recent cathode-ray tubes become larger in size increasingly.

Further, it has also been considered that, since a reinforcement band for use in anti-explosion is made of a steel and is relatively heavy, the volume and weight of the cathode-ray tube can be reduced by reducing the width of the reinforcement band, for example, so that the cathode-ray tube can be made light in weight.

However, according to the prior-art band reinforcement type arrangement, when the cathode-ray tube can be made light in weight by reducing the thickness of the glass or by reducing the volume of the reinforcement band, there cannot be maintained a sufficient anti-explosion characteristic.

For this reason, it is difficult to realize a cathode-ray tube which can be reduced in weight.

Further, even when the arrangement in which one functional film is attached to the face panel as mentioned before is employed, there is a possibility that a sufficient anti-explosion characteristic which can make the cathode-ray tube light in weight will not be obtained yet.

Accordingly, in order to make the cathode-ray tube light in weight, there are required countermeasures for further improving the anti-explosion characteristic.

As the countermeasures for improving the anti-explosion characteristic of the cathode-ray tube, there are generally proposed the following methods:

1) Fastening force of a heat shrink band should be optimized;

2) A panel glass should be increased in thickness;

3) A surface treatment with high elasticity such as a plate glass (safety panel) or polycarbonate should be effected on the panel glass;

4) A metal cover should be strongly fixed to the side surface of the panel by an adhesive agent (shell bond system);

5) A cathode-ray tube assembly should be fastened by a band having a rim which covers the peripheral portion of the face panel (rim band system); and

6) A frame-shape reinforcement plate should be closely contacted to the panel glass (Japanese laid-open patent application No. 2001-35419)

However, the above-mentioned respective countermeasures have the following respective defects:

First, even when the fastening force of the heat shrink band is optimized as in the countermeasure 1), since a degree to which the anti-explosion characteristic can be improved is small, the anti-explosion characteristic cannot always be improved sufficiently.

Moreover, the countermeasure 2) for increasing the thickness of the panel glass and the countermeasure 3) for effecting the highly-elastic surface treatment on the panel glass are both against the object for decreasing the weight of the cathode-ray tube, and therefore cannot be employed for the purpose of improving the anti-explosion characteristic in accordance with the above-mentioned decrease of the weight of the cathode-ray tube.

Further, although the shell bond system of the countermeasure 4) can suppress an amount of scattered glass, this countermeasure is not so effective for suppressing the implosion, and therefore cannot improve the anti-explosion characteristic sufficiently.

Since the rim band system of the countermeasure 5) has small fastening force of the band as compared with the heat shrink band, this countermeasure is not so effective for suppressing the implosion similarly to the shell bond system.

Since the frame-shape reinforcement plate of the countermeasure 6) is expensive as compared with the functional film, it is unavoidable that the cathode-ray tube should be manufactured expensively.

Further, when reinforced glass is used in the cathode-ray tube assembly, a stress of glass increases and a cracking of glass may progress earlier than glass which is generally used in the cathode-ray tube assembly. Therefore, it is difficult for the conventional arrangement of the cathode-ray tube to obtain the satisfactory anti-explosion characteristic.

In order to solve the above-mentioned problems, it is an object of the present invention to provide a cathode-ray tube capable of improving an anti-explosion characteristic as compared with an arrangement of a prior-art cathode-ray tube and which can be reduced in weight while maintaining a satisfactory anti-explosion characteristic.

### DISCLOSURE OF INVENTION

A cathode-ray tube has an arrangement in which a film is attached to a face panel of a cathode-ray tube assembly and in which this film is formed by laminating a plurality of films one on top of another.

According to the above-mentioned arrangement of the cathode-ray tube of the present invention, since the film, which is formed by laminating a plurality of films, is attached to the face panel of the cathode-ray tube assembly, the film whose strength (tensile strength, etc.) is relatively increased by laminating a plurality of films is attached to the face panel, whereby the face panel of the cathode-ray tube assembly can be reinforced.

### BRIEF DESCRIPTION OF DRAWINGS

FIG. 1 is a schematic diagram (perspective view) showing an arrangement of a cathode-ray tube according to an embodiment of the present invention; FIG. 2 is an enlarged cross-sectional view taken along the portion near the face panel of the cathode-ray tube shown in FIG. 1; FIG. 3 is a cross-sectional view of the film shown in FIG. 1; FIG. 4 is a schematic diagram (side view) showing an arrangement of a cathode-ray tube according to another embodiment of the present invention; FIG. 5 is an enlarged cross-sectional view taken along the portion near the face panel of the cathode-ray tube shown in FIG. 4; and FIG. 6 is a cross-sectional view showing a functional film according to the prior art.

### BEST MODE FOR CARRYING OUT THE INVENTION

The present invention is directed to a cathode-ray tube in which a film is attached to a face panel and in which this film is formed by laminating a plurality of films one on top of another.

According to the present invention, in the above-described cathode-ray tube, a reinforcement band is fitted into the outer periphery of a skirt portion of a panel portion of a cathode-ray tube assembly by a heat shrink treatment and the film is attached to the face panel so as to be extended over this reinforcement band.

Further, according to the present invention, in the above-described cathode-ray tube, the film is made of PET (polyethylene terephthalate).

Furthermore, according to the present invention, in the above-described cathode-ray tube, a plurality of films are laminated one on top of another with an adhesive material.

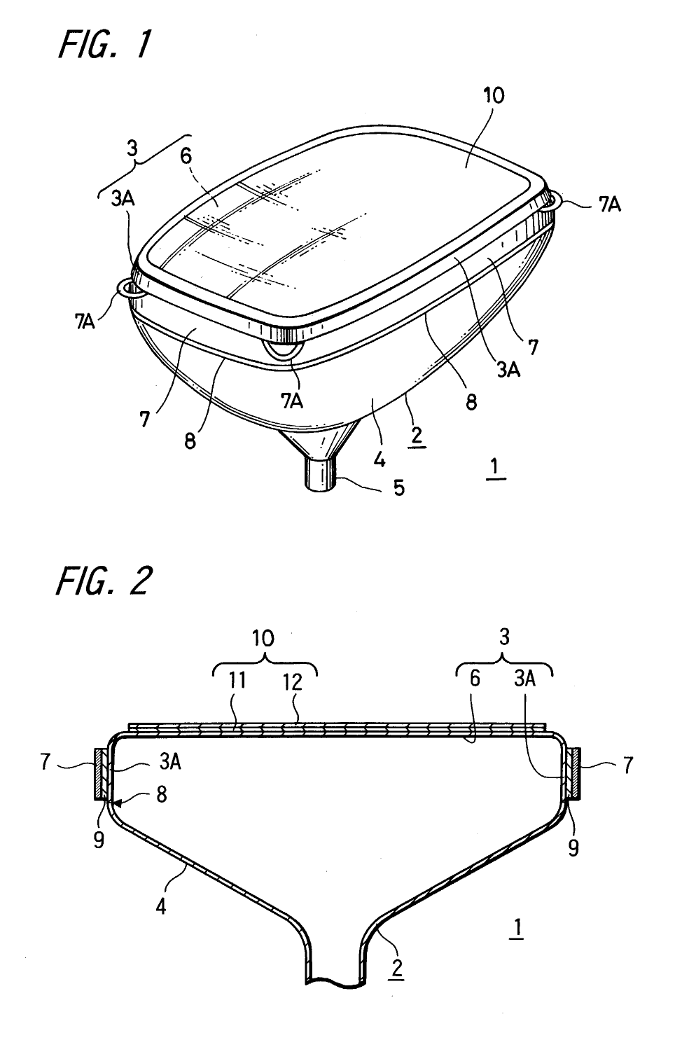

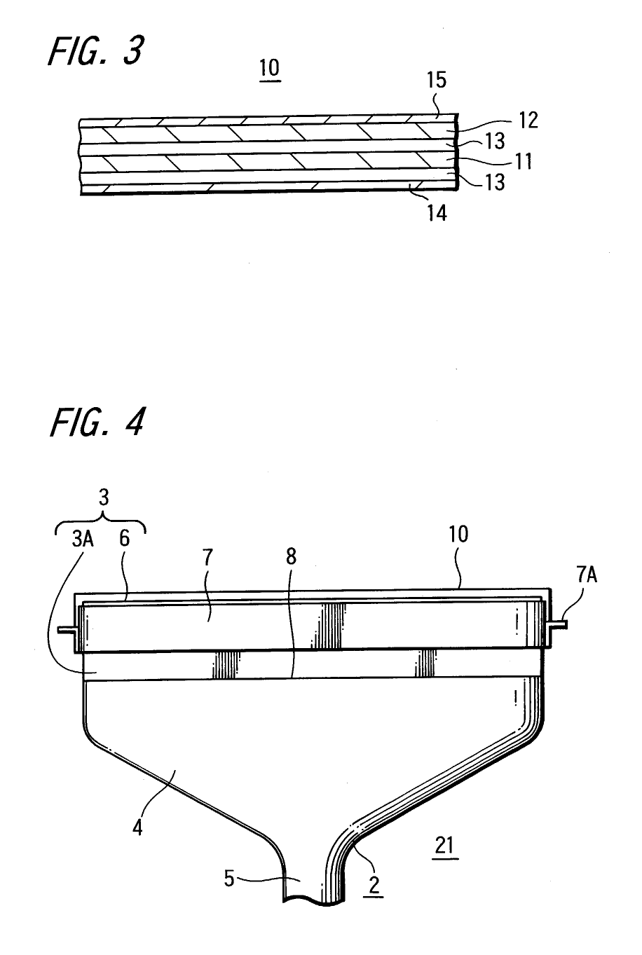

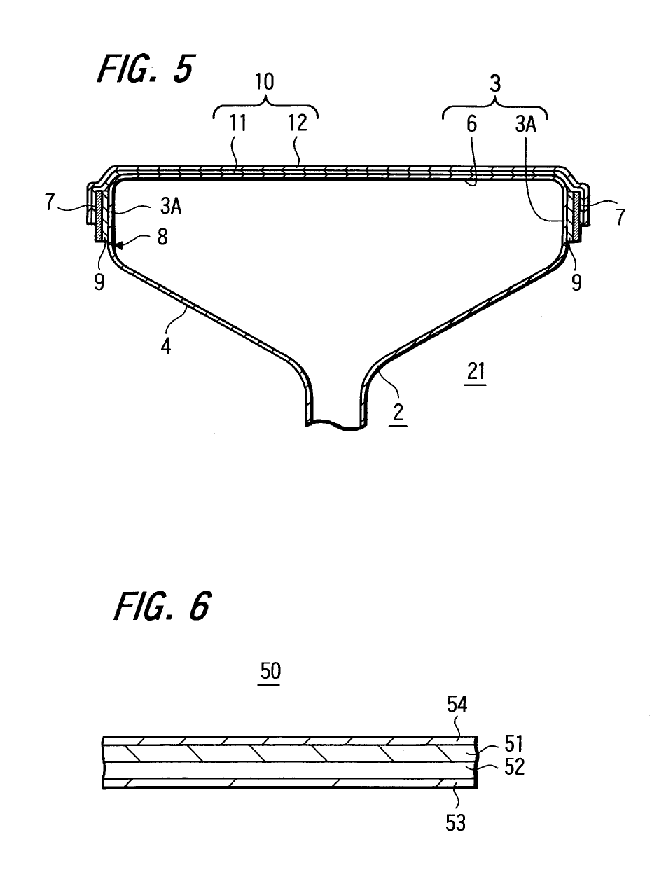

FIG. 1 is a schematic diagram (perspective view) showing an arrangement of a cathode-ray tube according to an embodiment of the present invention.

In this cathode-ray tube 1, an anti-explosion reinforcement band 7 made of a metal, e.g., a steel is fitted into the outer periphery of a skirt portion 3A of a panel portion 3 of a cathode-ray tube assembly 2 made of a suitable material such as glass. An electron gun (not shown) is provided within a neck portion 5 of the cathode-ray tube assembly 2. In the figure, reference numeral 7A denotes an attachment portion by which the reinforcement band 7 is mounted to the housing of the cathode-ray tube 1, and reference numeral 8 denotes a sealed line (so-called frit-sealed line) by which the panel portion 3 of the cathode-ray tube assembly 2 and a funnel portion 4 are sealed by fritting.

A film 10 is attached to the front surface of the panel portion 3 of the cathode-ray tube assembly 2, i.e., the surface of a face panel 6.

Further, FIG. 2 shows an enlarged cross-sectional view taken along the portion near the face panel 6 of the cathode-ray tube 1 shown in FIG. 1. FIG. 3 shows a cross-sectional view of the film 10.

In this embodiment, as shown in FIG. 2, the film 10 attached to, in particular, the face panel 6 is formed by laminating two films of a first film 11 and a second film 12. In FIG. 2, reference numeral 9 denotes a protection film 9 attached under the anti-explosion reinforcement band 7.

Then, as shown in the cross-sectional view of FIG. 3, the film 10 is a lamination layer film formed by laminating the first film 11, the second film 12 and a separate film 14 through adhesive materials 13. The separate film 14 is used to release the film from the adhesive material when the film 10 is attached to the face panel 6.

On the second film 12 which serves as the uppermost surface of the two films 11 and 12, there is formed a surface-treated layer 15 which has been surface-treated in various manners such as an anti-reflection coating treatment, an antistatic coating treatment or a hard coat treatment.

FIG. 6 shows a cross-sectional view of an ordinary one-sheet functional film as an example of a functional film for comparison with the aforementioned functional film.

This functional film 50 is formed by laminating a resin film 51 such as PET and a separate film 53 through an adhesive material 52. A surface-treated layer 54 is formed on the surface of the resin film 51.

The lamination layer film 10 according to this embodiment shown in FIG. 3 can be made of the materials similar to those of the conventional functional film 50, an increase of costs of the materials thereof is small and this lamination layer film can be manufactured with ease.

As the materials of the two films 11 and 12 which are laminated, there can be used well-known materials. For example, there can be used resin films such as a PET (polyethylene terephthalate) film and a TAC (triacetate-based) film.

When these laminated two films 11 and 12 have the same film thickness and are made of the same material, there can be obtained advantages in which the cost of the material can be reduced and in which the lamination layer film 10 can be manufactured with ease.

However, the materials of these two films and the film thicknesses of these films are not limited to, in particular, the same material and the same film thickness, and there can be used films made of different materials and which are different in film thickness.

The adhesive material 13, which is used to bond together a plurality of films 11 and 12, may have at least a light transmission characteristic and may be well-known materials. For example, there can be used adhesive materials such as an acrylic adhesive material, an epoxy adhesive material or a silicon adhesive material.

Further, as shown in FIG. 3, between the separate film 14 and the first film 11, there can be used the same adhesive material 13 as the adhesive material 13 which is used to bond the two films 11 and 12 to each other. At that very moment, the separate film 14 can be released from the adhesive material 13 by adjusting releasing force of the separate film 14 relative to the adhesive material 13.

The first film 11 and the separate film 14 maybe laminated by using an adhesive material whose material or film thickness is different from that of the adhesive material 13 which is used to bond the two films 11 and 12 to each other.

In particular, as an adhesive material used when a plurality of PET films are laminated, there may be suitably used an acrylic light-curing type adhesive material.

Further, when this acrylic light-curing type adhesive material is used as the above-mentioned adhesive material, it is to be desired that a thickness of the adhesive material should fall within a range of from 10 to 30 μm and that an adhesive strength should be larger than 0.5 kg/inch (30 ±5 minutes) in the initial adhesion and should be larger than 3.0 kg/inch (24 hours and more) in the permanent adhesion.

According to the above-mentioned embodiment, since the film 10, which is formed by bonding the two films of the first film 11 and the second film 12 to each other, is attached to the surface of the face panel 6, the film 10 whose strength was increased by the two films 11 and 12 thus laminated together is attached to the surface of the face panel and the film 10 can serve as a cushion film to absorb a shock from the outside.

As a consequence, the face panel 6 can be reinforced and an anti-explosion characteristic can be improved.

Further, since the thickness of the film 10 increases, when compared with a case in which only one film is attached to the surface of the face panel, the overall strength can increase and therefore the film 10 can become difficult to break.

That is, since the strength of the film 10 itself increases, the anti-explosion characteristic can be improved more.

In addition, since the strength of the film 10 itself is improved when the above laminated two films are attached to this film, the anti-explosion characteristic can be improved much more than a case in which two films are attached to the face panel one by one, as will be described later on.

Moreover, since the film 10 comprised of the lamination layer film can be released from the cathode-ray tube assembly 2 later on, glass of the cathode-ray tube assembly 2 can be recycled with ease.

Further, as compared with the case in which a sheet of functional film 50 (see FIG. 6) is attached to the surface of the face panel according to the prior art, only the number of films is increased and a similar surface-treatment method and similar manufacturing equipment can be used.

Furthermore, regardless of the specification of the cathode-ray tube 1, a cathode-ray tube may have an arrangement in which the film 10 is attached to the face panel 6.

Although a lamination film can be formed by bonding together two functional films 50 shown in FIG. 6 through an adhesive material instead of the lamination layer film 10 shown in FIG. 3, the surface-treated layer 54 ends up inevitably as an inside film. Therefore, the material cost increased by this surface-treated layer 54 and the impact exerted upon the strength of the lamination layer film by this surface-treated layer should be taken into consideration.

Further, FIG. 4 shows a side view of a cathode-ray tube according to another embodiment of the present invention. FIG. 5 shows an enlarged cross-sectional view taken along the portion near the face panel of the cathode-ray tube shown in FIG. 4.

As shown in FIGS. 4 and 5, in a cathode-ray tube 21 according to this embodiment, a similar film (lamination layer film) 10 to that of the cathode-ray tube 1 according to the preceding embodiment is further extended to the outside of the face panel 6.

Then, the film 10 is attached to the face panel so as to be extended to the reinforcement band 7 which is fitted into the outer periphery of the skirt portion 3A of the panel portion 3 by a heat shrink treatment.

The rest of the arrangement is similar to that of the cathode-ray tube according to the preceding embodiment. Hence, identical elements and parts are denoted by identical reference numerals and an overlapping explanation therefor will be omitted.

When the cathode-ray tube 21 according to this embodiment is manufactured, there is prepared a lamination layer film 10 having a wide area as is extended more to the outside of the face panel than the lamination layer film 10 according to the preceding embodiment.

Then, the lamination layer film is attached to the face panel in such a manner that the extended portion may cover the reinforcement band 7.

When the film 10 shaped like a rectangle, for example, is in use, the film 10 overlaps at four corners of the skirt portion 3A. Accordingly, these overlapping portions at the four corners are folded in the same manner as to fold and wrap a box with a wrapping paper, for example.

Further, the film 10 may be shaped like a film in which four corners are removed from a rectangle, whereby the film 10 can be prevented from overlapping at the four corners of the skirt portion 3A.

When the edge (end edge) of the reinforcement band 7 has a corner portion, there is a possibility that this corner portion will crack the film 10. Therefore, it is to be desired that the film 10 should be attached to the face panel after the above edge has been covered with a suitable material such as a protection tape. Moreover, in order to prevent the film from being cracked, it is effective to chamfer the edge of the reinforcement band.

On the other hand, when the reinforcement band 7 whose edge on the face panel 6 side is folded in order to maintain a larger strength is employed, since the edge of the reinforcement band is folded, the edge has no corner portion and is thereby shaped like a curved surface. Therefore, it may be considered that without covering the edge with a suitable means such as a protection film, an impact exerted upon the film 10 by the edge is negligible.

According to the above-mentioned embodiment, since the film 10 is attached to the face panel so as to be extended up to the reinforcement band 7, when the cathode-ray tube is imploded, the face panel 6 can be prevented from being inwardly burst into the cathode-ray tube assembly 2 together with the film 10 and glass at a blended R portion between the face panel 6 and the skirt portion 3A from being scattered.

Therefore, it is possible to improve the anti-explosion characteristic of the cathode-ray tube according to this embodiment more than that of the preceding embodiment.

We manufactured sample cathode-ray tubes in which films were attached to face panels in actual practice. Then, we made anti-explosion tests with respect to these sample cathode-ray tubes and compared anti-explosion characteristics of these sample cathode-ray tubes.

In 36-inch cathode-ray tubes, each having an aspect ratio of 16:9, and in which reinforcement bands were fitted into the outer periphery of the skirt portion of the panel portion of the cathode-ray tube assembly by the heat-shrink treatment, we manufactured cathode-ray tubes in which films were attached to the surfaces of the face panels.

[Sample 1]

A first PET film having a thickness of 188 μm was attached to the surface of a face panel so as to be extended over a reinforcement band with an adhesive material. Thereafter, a second PET film having a thickness of 188 μm was attached to the surface of the first PET film, and we have employed a resultant cathode-ray tube as a sample 1. That is, the sample 1 has the two PET films, each having the thickness of 188 μm, sequentially attached from the face panel to the reinforcement band.

The 188 μm-thick PET film is generally used when a sheet of functional film is attached to the surface of the face panel.

[Sample 2]

There was formed a lamination layer film in which two PET films, each having a thickness of 100 μm, laminated with an adhesive material in advance. Subsequently, the lamination layer film was attached to the surface of the face panel so as to be extended over the reinforcement band with an adhesive material, and we have employed a resultant cathode-ray tube as a sample 2. That is, the sample 2 has a similar arrangement to that of the cathode-ray tube according to the embodiment shown in FIGS. 4 and 5.

Arrangements such as the cathode-ray tube assembly or the reinforcement band other than the lamination layer film were the same as those of the first sample 1.

We have made the anti-explosion tests on these samples 1 and 2. Results of the anti-explosion tests are shown in a table 1.

TABLE 1

| | | Anti-explosion test |
|---|---|---|
| | Film specification | result |
| Sample 1 | Two sheets of 188 μm-thick | Film could not endure |
| | films were attached. | implosion and was broken and |
| | | dropped. |
| Sample 2 | (100 + 100) μm-thick | Film was broken and dropped, |
| | lamination layer film was | and heat-shrink band was |
| | attached. | deformed. |

The fact that the heat-shrink band in the sample 2 was deformed shows that the film had endured the bursting flow of air produced upon implosion.

It is to be considered that the sample 1 cannot endure shock of implosion although it has the integrated thickness which is about twice as large as the thickness of the surface-treated film of the sample 2.

Therefore, it is to be understood that the sample 2 in which the lamination layer film of the two sheets of film is attached to the face panel is stronger against the shock of implosion rather than the sample 1 in which two sheets of film are attached to the face panel one by one.

Furthermore, since the sample in which the lamination layer film comprising the two laminated sheets of film can decrease the integrated thickness, an increase in the cost of the material of the films can be suppressed.

[Sample 3]

We formed a lamination layer film in which two sheets of PET film, each having a thickness of 100 μm, were laminated with an adhesive material in advance. Subsequently, the lamination layer film was attached to the surface of the face panel so as to be extended over the reinforcement band with the adhesive material, and we have employed a resultant cathode-ray tube as a sample 3. That is, the sample 3 has a similar arrangement to that of the cathode-ray tube of the embodiment shown in FIGS. 4 and 5.

The integrated thickness of the lamination layer film of the sample 3 is 200 μm.

Although the arrangement of the film of the sample 3 is similar to that of the film of the sample 2, the reinforcement band has specifications different from those of the sample 2.

[Sample 4]

We formed a lamination layer film in which two sheets of a first PET film having a thickness of 188 μm and a second PET film having a thickness of 125 μm were laminated with an adhesive material in advance. Subsequently, the lamination layer film was attached to the surface of the face panel so as to be extended over the reinforcement band, and we have employed a resultant cathode-ray tube as a sample 4. That is, the sample 4 has a similar arrangement to that of the cathode-ray tube according to the embodiment shown in FIGS. 4 and 5.

The integrated thickness of the lamination layer film of the sample 4 is 313 μm and which is about 1.5 times as large as that of the sample 3.

Arrangements such as the cathode-ray tube assembly or the reinforcement band other than the lamination layer film were the same as those of the sample 3.

We have made the anti-explosion tests on these samples 3 and 4. Results of the anti-explosion tests are shown on a table 2.

TABLE 2

| | | Anti-explosion test |
|---|---|---|
| | Film specification | result |
| Sample 3 | (100 + 100) μm-thick | Although film was broken, |
| | lamination layer film was | upper and lower portions of |
| | attached to face panel. | film are barely attached to |
| | | face panel and heat-shrink |
| | | band was deformed |
| | | considerably. |
| Sample 4 | (188 + 125) μm-thick | Although only lower portion |
| | lamination layer film was | of film was attached to face |
| | attached to face panel | panel, film was broken |
| | | little, heat-shrink band was |
| | | deformed considerably and |
| | | welding portion of holder |
| | | portion for supporting the |
| | | whole of heat-shrink band was |
| | | detached |

A study of the table 2 reveals that, although the film of the sample 3 has absorbed the shock, the sample 4 has endured the shock to the extent that the welding portion of the heat-shrink band is detached.

Since the degree to which the film of the sample 4 was broken is small, it is to be understood that the strength of the film increases with the increase of the thickness of the film.

Further, it is to be supposed that, if the film could support itself such that it may not be broken, then glass of the cathode-ray tube assembly would be prevented from being scattered.

[Sample 5]

We formed a lamination layer film in which two sheets of a first PET film having a thickness of 188 μm and a second PET film having a thickness of 125 μm were laminated with an adhesive material in advance (the same arrangement as that of the lamination layer film of the sample 4). Subsequently, the lamination layer film was attached to only the surface of the face panel with an adhesive material and we have employed a resultant cathode-ray tube as a sample 5. That is, the sample 5 has not attached the lamination layer film to the reinforcement band and has a similar arrangement to that of the cathode-ray tube according to the embodiment shown in FIGS. 1 and 2.

Since the lamination layer film is not attached to the reinforcement band, the area of the lamination layer film becomes smaller than that of the sample 4.

The face panel of the cathode-ray tube was reinforced by joining the end edge of the lamination layer film and the end edge of the reinforcement band with an adhesive tape simply and easily (about twice).

[Sample 6]

We formed a lamination layer film whose arrangement was the same as that of the lamination layer film of the sample 5 in advance. Subsequently, the lamination layer film was attached to the surface of the face panel so as to be extended over the reinforcement band, and we have employed a resultant cathode-ray tube as a sample 6. That is, the sample 6 has a similar arrangement to that of the cathode-ray tube according to the embodiment shown in FIGS. 4 and 5.

Since the lamination layer film is attached to the face panel so as to be extended over the reinforcement band, the area of the lamination layer film of this sample is larger than that of the lamination layer film of the sample 5 and is similar to that of the lamination layer film of the sample 4.

In order to prevent the edge of the reinforcement band from becoming a starting point at which the film begins to crack, the edge was protected repeatedly by a suitable means such as a protection tape and the size of the film was increased so that the film was closely attached to the reinforcement band so as to cover the reinforcement band with room.

We have made the anti-explosion tests on these samples 5 and 6. Results of the anti-explosion tests are shown on a table 3.

TABLE 3

| | | Anti-explosion test |
|---|---|---|
| | Film specification | result |
| Sample 5 | (188 + 125) μm-thick | Although film was held |
| | lamination layer film was | substantially, a large amount |
| | attached to face panel. | of glass was scattered from |
| Sample 6 | (188 + 125) μm-thick | a broken portion of the film. |
| | lamination layer film was | Film was completely held but |
| | attached to face panel | cracked partly. |
| | (closely attached to | |
| | reinforcement band). | |

A study of the table 3 reveals that, although the film of the sample 6 was partly cracked at its central portion, the film of this sample has still maintained its shape after it was imploded so that an amount of scattered glass was decreased considerably as compared with that of the sample 5. Therefore, it is to be understood that the anti-explosion characteristic can be improved by attaching the film to the face panel so as to be extended over the reinforcement band.

We made the anti-explosion tests on the samples of the tables 1, 2 and 3 under the same standards and the same conditions.

However, since the specifications of the respective reinforcement bands are different from each other, the respective test results in the tables 1, 2 and 3 are independent from each other, and therefore the results in the respective tables cannot be compared with each other simply and easily.

While the lamination layer film 10 is formed by laminating the two films 11 and 12 in the above-mentioned respective embodiments, the present invention is not limited thereto and a lamination layer film may be formed by laminating more than three sheets of film.

In that case, various surface treatments such as anti-reflection coating or antistatic coating may be effected on at least a film which becomes the uppermost surface of a plurality of films.

The present invention is not limited to the above-mentioned embodiments and can take various modifications without departing from the gist of the present invention.

According to the above-mentioned present invention, since the film, formed by laminating a plurality of films, is attached to the surface of the face panel of the cathode-ray tube, the resultant film can achieve a cushion effect to alleviate the shock of implosion.

Further, since a plurality of films are laminated so that the strength of the film itself may be increased, the anti-explosion characteristic can be improved effectively as compared with the case in which a plurality of films are attached to the surface of the face panel one by one. As a consequence, the film thickness of the films, which are required to obtain the same anti-explosion characteristic, can be decreased so that the cost of the material can be reduced.

Therefore, the anti-explosion characteristic can be improved more as compared with the prior-art cathode-ray tube by using the same conventional anti-explosion reinforcement band.

On the other hand, although the volume of the anti-explosion reinforcement band is reduced and the thickness of glass of the cathode-ray tube assembly is decreased as compared with the prior-art cathode-ray tube, it becomes possible to maintain the anti-explosion characteristic equal to that of the prior-art cathode-ray tube.

Therefore, it becomes possible to realize a cathode-ray tube which can be made light in weight.

Furthermore, particularly when the film is attached to the face panel so as to be extended over the reinforcement band, it becomes possible to improve the anti-explosion characteristic more.

1. (Amended) A cathode-ray tube characterized in that a cathode-ray tube assembly has a film attached to a face panel thereof to reinforce the strength of said face panel, said film being formed of a plurality of laminated films.

2. A cathode-ray tube according to claim 1, wherein said cathode-ray tube assembly includes a panel portion having a skirt portion the outer periphery of which is reinforced with a reinforcement band fitted thereto by a shrinkage-fitting treatment and said film is attached up to said reinforcement band.

3. A cathode-ray tube according to claim 1, wherein said film is made of PET (polyethylene terephthalate).

4. A cathode-ray tube according to claim 1, wherein said plurality of films is laminated with an adhesive material.
